(19) United States
(12) Patent Application Publication
(10) Pub. No.: US 2006/0085381 A1
(43) Pub. Date: Apr. 20, 2006

(54) Remote deployment access system and method

(75) Inventors: Chris Fugate, Waterloo, WI (US); Srividya Chandramohan, Cary, NC (US)

Correspondence Address: GODFREY & KAHN S.C., 780 NORTH WATER STREET, MILWAUKEE, WI, 53202, US

(73) Assignee: Epic Systems Corporation

(21) Appl. No.: 10/969,479

(22) Filed: Oct. 20, 2004

(51) Int. Cl. G06F 17/30

(52) U.S. Cl. 707/1

(57) ABSTRACT

The present invention provides a system and method for rapidly and efficiently transferring, manipulating and accessing data located in different environments, locations and platforms. The present invention is a remote deployment access system and method for allowing multiple simultaneously connections to remote services by access at different locations. The present invention includes a base deployment having a first data repository for accessing, storing or manipulating data; at least one remote deployment having a second data repository for accessing, storing or manipulating data; a user interface for the base deployment for accessing, storing or manipulating the first or second data repository; and a pool manager having at least one session connecting the base deployment and the at least one remote deployment.

### BACKGROUND OF THE INVENTION

The present invention generally relates to systems and methods for accessing multiple software applications at different locations and specifically relates to a system and method for seamlessly sharing data and software applications across various platforms, multiple environments, and in different locations.

When dealing with large datasets and configuration settings that are varied across environments, present systems such as Citrix® allow transfer of data such that a user needs to open multiple operating windows and authenticate each window for security configurations before being able to access the data. Typically, this operation is neither efficient nor elegant. Problems are enhanced especially if one database system is located in Los Angeles, and another is located in New York, and data needs to be accessed from Chicago. Furthermore, the present state of art creates additional inefficiencies if rapid data access is desired across databases, platforms or environments when database systems are located in different countries such as United States, India or China.

Accordingly, the need exists for a remote deployment access system and method that can be efficiently used for rapid access of data from across databases, platforms and environments within a short duration of time. Of course, the present invention may be used in a multitude of systems where similar transfer of data is desired. Thus, the present invention should not be interpreted as being limited to application in connection with remote deployment systems for multiple databases.

### SUMMARY OF THE INVENTION

In a preferred embodiment, the present invention provides a remote deployment access system for use in accessing, storing or manipulating information from at least one remote deployment system. Generally the deployment system comprises (a) a base deployment system having a first data repository for accessing, storing or manipulating data; (b) at least one remote deployment system having a second data repository for accessing, storing or manipulating data; (c) a user interface for the base deployment system for accessing, storing or manipulating the first or second data repository; and (d) a pool manager system having at least one pool session connecting the base deployment and the remote deployment systems.

Further, the base or remote deployment system comprises a plurality of software applications. A user may therefore move between software applications on the same remote deployment system or the same software applications running on different deployment systems.

Preferably, the user initiates a session from at least one software application on the base deployment system. The user further initiates a request for a remote session from within the initial session to access the remote deployment system. Behind the scene, the initial deployment system, which includes a launch manager system, sends a request for the remote session to the pool manager system. The remote deployment access system, which also includes a locator system, identifies a suitable remote session upon request from the user. Generally, the request for the remote session includes authentication information and/or context information.

Further, the remote deployment system also includes a database server system. The locator system therefore collects user-entered parameters from the user interface and queries this database server system. The database server system, in turn, responds with a suitable remote deployment system. The locator system uses this information to request a session from the pool manager system to the identified remote deployment system. The pool manager system, in turn, uniquely identifies a corresponding remote session. Security clearance of the user in the base deployment system provides the authentication information to the remote deployment system. Consequently, upon authentication, the pool manager system sends a message to the base deployment system identifying this unique session. The pool manager system then disconnects from the uniquely identified session. The base deployment system then connects to this newly available session using the information sent from the pool manager system. A custom virtual channel is created within the remote session for communication and control between the base and remote sessions. Finally, upon the pool manager system's disconnection from the original remote session, a second remote session between the pool manager system and the remote deployment system is initiated, such that at least one remote session always exists between the pool manager and the remote deployment system.

In another preferred embodiment, the present invention provides a remote deployment access system for use in accessing, storing or manipulating information from at least one remote deployment system, comprising (a) a base deployment system comprising at least one health enterprise information system having a first data repository for accessing, storing or manipulating data; (b) at least one remote deployment system having a second data repository for accessing, storing or manipulating data; (c) a user interface for the base deployment system for accessing, storing or manipulating the first or second data repository; and (d) a pool manager system having at least one pool session connecting the base deployment and the remote deployment systems.

In yet another preferred embodiment, the present invention provides a method of accessing, storing or manipulating information from at least one remote deployment system. The method includes the steps of (a) initiating a pool session from a base deployment system; (b) maintaining at least one first remote session for each remote deployment system; (c) sending a request to a pool manager system for a first remote session; (d) identifying a suitable remote deployment system; (e) authenticating request from a user and responding to the base deployment system with session information for the first remote session; and (f) connecting the base deployment system to the first remote deployment system via a direct virtual channel.

Preferably, the first remote session is disconnected once the virtual channel is established and a second remote session between the pool manager system and the remote deployment system is launched. Furthermore, preferably the base deployment system and/or the remote deployment system operate on the enterprise health information system.

In sum, the present invention represents a significant improvement over the prior art in many ways, including allowing quick and seamless connection between multiple databases existing is varied platforms and environments. These and other objects and advantages of the present invention will become apparent from the detailed description and claims accompanying the drawings.

### BRIEF DESCRIPTION OF THE DRAWINGS

FIG. 1 is a block diagram of an embodiment of a remote deployment access system and method in accordance with the present invention;

FIG. 2 is another block diagram of the remote deployment access system and method of the present invention; and

FIG. 3 is a sample screen shot of a software application program in a health care environment that is using the present invention to access patient information located in the patient's home deployment from a remote deployment.

### DETAILED DESCRIPTION OF THE INVENTION

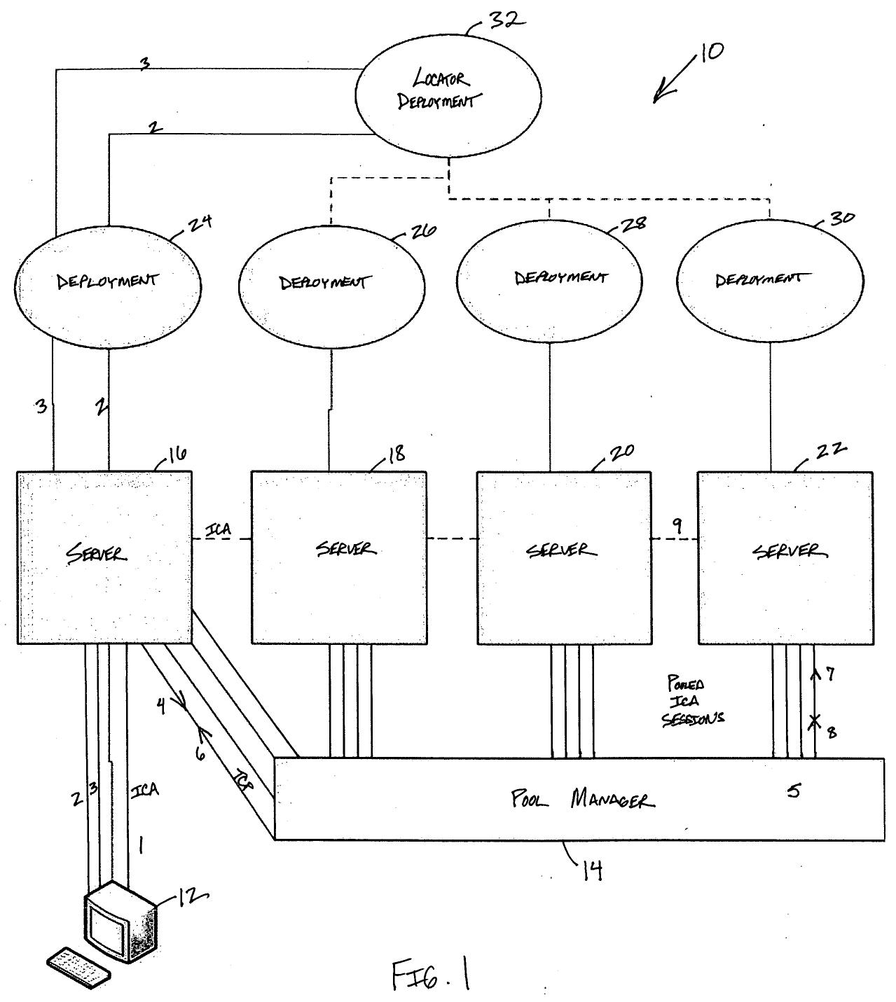

Referring now to the drawings, FIG. 1, illustrates a block diagram of an embodiment of a remote deployment access system 10 for use in accessing, storing or manipulating information from at least one remote deployment system in accordance with the present invention. Generally the remote deployment access system comprises (a) a base deployment 24 having a first data repository for accessing, storing or manipulating data; (b) at least one remote deployment 26, 28, 30, each having a second data repository for accessing, storing or manipulating data; (c) a locator deployment 32 (EMPI) for locating the proper deployment; (d) a user interface 12 for the base deployment for accessing, storing or manipulating the first or second data repository; and (e) a pool manager 14 having at least one session connecting the base deployment and the remote deployment. The pool manager 14 has connections to a plurality of servers 16, 18, 20, 22 and in turn to each deployment 24, 26, 28, 30.

Further, the base or remote deployments 24, 26, 28, 30 comprise a plurality of software applications that are accessible by a user 12. A user may therefore move between software applications on the same remote deployment or the same applications running on different remote deployments.

Preferably, the user initiates a pool session from at least one software application on the base deployment system. The user further initiates a request for a remote session from the pool session to access the remote deployment system. Behind the scene, the remote deployment access system, which includes a launch manager, sends a request for the remote session to the pool manager. The remote deployment access system, which also includes a locator system, identifies a suitable remote session upon request from the user. Generally, the request for the remote session includes authentication information and/or context information.

Further, the remote deployment system also includes a database server. The locator therefore collects user-entered parameters from the user interface and queries this database server system. The database server system in turn responds with a suitable remote deployment system and launches a new pool session. The identity of the user in the base deployment provides the authentication information. The pool manager system uniquely identifies the remote session. Consequently, upon authentication, a connection from the user from the base deployment is made to the remote deployment. Further, this causes disconnection of the remote session between the pool manager system and the remote deployment system. The session is disconnected upon access, manipulation or storage of data on the first or second repository. Finally, upon disconnection a second remote session between the pool manager and the remote deployment is initiated, such that at least one remote session always exists between the pool manager and the remote deployment system.

In operation, the method can be described as follows: (1) a connection is made to an ICA session from the client 12 to one of the servers 16 and up through the deployments 24 to a locator deployment 32; (2) the locator deployment 32 requests for a correct deployment; (3) the pool manager 14 identifies the correct deployment; (4) the pool manager 14 requests an ICA session from the identified correct deployment from the locator deployment, which occurs over a configured TCP port (included in this request is an authentication and context for the ICA session); (5) the pool manager 14 decides on the correct polled ICA session; (6) the pool manager 14 sends a unique identifier for the session; (7) the pool manager 14 sends context information down a custom virtual channel to change the identified session into the required context; (8) the pool manager 14 disconnects the ICA session between the server 22 and the pool manager 14; and (9) the client 12 connects to the correct ICA session with information from the unique identifier.

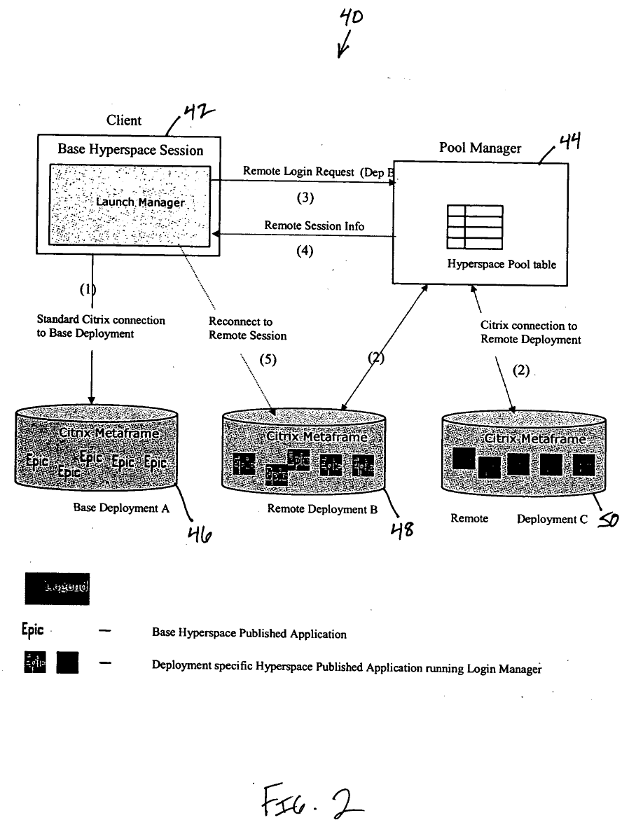

FIG. 2 is another block diagram of another embodiment of a remote deployment access system 40 of the present invention. In this embodiment, the present invention provides a remote deployment access system 40 for use in accessing, storing or manipulating information from at least one remote deployment system, comprising (a) a base deployment 46 comprising at least one health enterprise information system (not shown) having a first data repository for accessing, storing or manipulating data; (b) at least one remote deployment 48, 50 having a second data repository for accessing, storing or manipulating data; (c) a user interface 42 for the base deployment for accessing, storing or manipulating the first or second data repository; and (d) a pool manager 44 having at least one ICA session connecting the base deployment with the remote deployment.

Preferably, in the remote deployment access system a session is established between the first enterprise health system and a second health enterprise information system on the remote deployment base system. Further, the remote deployment access system has a user interface includes a graphical interface representing at least one remote deployment system which displays an interactive map view of the remote deployment base system. The graphical interface allows a user to perform actions on a patient in a health care facility and allows a user to direct workflow between the base deployment system and the remote deployment system. Preferably, the workflow includes but is not limited to a call center, nurse triage, appointment scheduling, patient record viewing or manipulation, laboratory results, inpatient clinical record, ambulatory record, hospital billing, professional billing, provider information, physician information, prescription medication pharmacy information or insurance information. Upon request from a user, the locator system identifies suitable remote session for the user's workflow based on workflow context, including patient information, schedule information, location information or department information.

In yet another preferred embodiment, the present invention provides a method of accessing, storing or manipulating information from at least one remote deployment system. The method includes the steps of (a) initiating a session from a base deployment; (b) maintaining at least one first remote session for each remote deployment; (c) sending a request to a pool manager for a first remote session; (d) identifying a suitable remote deployment; (e) authenticating request from a user and responding to the base deployment with session information for the first remote session; and (f) connecting the base deployment to the first remote deployment via a session.

Preferably, the first remote session is disconnected once the session is established and a second remote session between the pool manager and the remote deployment is launched. Furthermore, preferably the base deployment and/or the remote deployment operate on an enterprise health information system.

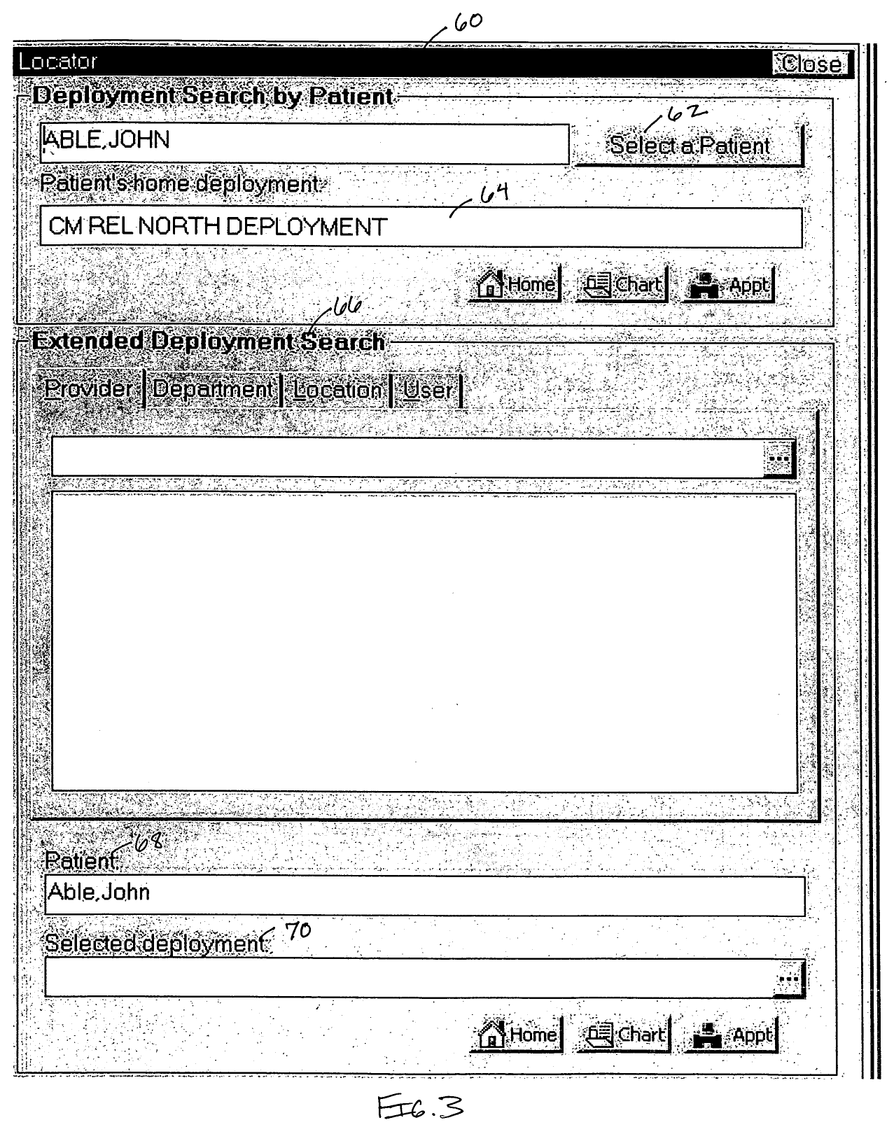

FIG. 3 is a sample screen shot 60 of a software application program in a health care environment that is using the present invention to access patient information located in the patient's home deployment 64 from a remote deployment location 70. The screen shot 60 shows a deployment locator searching for patient information on a particular patient 62 from the patient's home deployment 64. The patient's name 68 and selected deployment 70 is shown. The system allows a user to conduct an extended deployment search 66 by provider, department, location and user.

The following example is for illustration purposes only and should not be deemed as limiting the scope of the invention:

### EXAMPLE I

This example provides application of the present invention in the field of Medical software, as provided by Epic Systems Corporation, Madison Wis. Generally this example illustrates technical details of remote deployment access system with Pooled Hyperspace® Citrix® sessions, also referred to as pooled sessions.

When large health care organizations span many autonomous regions, users must be able to share data seamlessly among multiple environments. When supporting Epic® applications in this context, large data sets and configuration settings must be kept synchronized across these environments. In some cases, a remote deployment access system can provide a simple alternative to using a synchronization methodology (for this example, exclusively, a deployment refers to a particular region running an instance of the Epic® applications. These instances may be of the same or different versions of Epic® software). Some application workflows (such as call center, nurse triage, secure messaging access, and appointment scheduling workflows) need to directly access the record on the target deployment rather than bringing the records to the current deployment (via copying or synchronization). For example, a patient whom normally receives care, in the ‘California—Los Angelis’ deployment contacts an office in the ‘New York—New York’ deployment and wants to schedule an appointment in ‘Illinois—Chicago’ deployment. In this case, the person in New York scheduling the appointment should have the option of remotely accessing the patient record in Los Angeles and scheduling the appointment there.

Remote deployment access systems may be supported using a standard Citrix® infrastructure by maintaining a pool of application sessions on different Citrix® servers for each of the deployments. Through a process of requests and acknowledgements, a session can be handed off from the pool to a requesting client. This handoff happens much faster than the standard method of creating a new Citrix ICA session to connect to Hyperspace, since the ICA session creation in addition to the Windows® and Hyperspace logins is bypassed.

Any Citrix session, when launched, has to go through the following stages (only the relevant steps are mentioned here): Locating a server, identifying whether the user logging into the Citrix server has a valid account, launching the published application, connecting to the published application and maintaining active state. Further, the process may include the steps of initiating actions with the launched application such as opening a patient record, and going to a specific activity such as appointment scheduling or a clinical triage activity.

Launching a new session can be time consuming. In order to reduce the overall time taken to respond to a remote access request, in the present invention the remote deployment access system jump starts a number of sessions on Citrix, such that the above-mentioned stages are already completed when a new request comes.

Hyperspace login manager may be used for user authentication and context for remote deployment access system components. Hyperspace can also provide basic notifications of user context changes. A context change may comprise a user moving from a scheduling workflow to a clinical workflow, a clinical workflow to a billing workflow, etc.

In operation, the user experiences the following steps while accessing a remote/base deployment as depicted in FIG. 2:

(1) Client launches Hyperspace on base deployment system

(2) A Pool Manager maintains several active Hyperspace sessions per remote deployment system (this happens in the background unknown to the user).

(3) From the client, Launch Manager sends request to Pool Manager for remote access to a Hyperspace session on a remote deployment system.

(4) Pool Manager requests and receives authentication and context information.

(5) Pool Manager grants request and responds with information about remote session.

(6) Client connects to the remote session.

Each deployment has a unique published application running on the Citrix Metaframe®. For Epic, this would correspond to a different version of Hyperspace application with a unique application name. For example, deployment (abbreviated as Dep) A would run “HypA”, Dep B would run “HypB” and so on. Each published app is managed by Citrix. Each application runs on many Citrix servers. Management of the connections is done by Citrix load-balancing.

Client workstation (also referred to as base deployment or host) operates Hyperspace via a standard Citrix connection on base deployment. From the base Hyperspace session, a user initiates request to launch a remote session on remote deployment B. Launch Manager sends this request to the Pool Manager. The Pool Manager replies back with the information that uniquely identifies a session that is running “Hyp B” on Dep B. Using the session information; the host reconnects itself to this new session. This is done dynamically using Citrix API and ICA client object running on the host. This eliminates the need for static ICA files on the host to connect to each and every remote deployment.

Launch Manager determines which Pool Manager to connect to. The information to be published about the Pool Manager include Server name, IP address and Listening port

Generally, the listener on the Pool Manager that talks to clients could be implemented in numerous ways known to one of ordinary skill in the art. For example, implementation may occur in the following ways, listed according to increasing order of complexity:

(1) Using Microsoft Winsock control over TCP/IP

(2) Web service

(3) Custom business service developed with standard software development tools.

In the Epic application, preferably, the Launch Manager sends the following information to the Pool Manager:

(1) Deployment identifier (name or number)—remote deployment to connect to

(2) Secret key to establish trust

(3) Epic User ID

(4) Workstation ID

(5) Environment ID

(6) Secondary login values—Department ID, Role ID etc

(7) Application context—patient ID, activity descriptor etc

(8) Screen size/resolution

In response to the request from the Launch Manager the Pool Manager contains the following session information:

(1) User name

(2) Password

(3) Application name

(4) Remote server name

Preferably in this Epic Application, the username and password is common for all users on a Citrix server. Therefore, in order to uniquely identify a session, a unique application name per Citrix server is established, even while maintaining only one copy of the application. For example, this application may be published under several names (HypB1, HypB2 etc) on each server.

Furthermore, once the request/response sequence is completed, Launch Manager could launch the remote session on the client by either launching on host Citrix server or launching on host/client workstation locally. Therefore, the host Citrix server may not be part of the “pool”, however, a remote session may be launched within the Citrix process that is running the host Hyperspace session. Moreover, local processing power and memory capacity of the clients may be utilized and remote sessions may be locally launched. This method prevents penalizing other users connecting to host Citrix server. ICA Client object may need to be installed either on all workstations or all Citrix servers (A current ICA client will need to be installed on the local workstation and the MetaFrame Presentation server).

In a preferred aspect, the Client Session may be managed such that the Launch Manager maintains a list of the remote sessions that were requested and launched. Existing remote sessions may be reused when a new request for the same deployment comes through. Therefore, the host may run one remote session per deployment, while maintaining the capacity to connect to more than one remote deployment systems at a time. A maximum limit on number of sessions may be imposed by system resources and configurable server settings.

Also preferably, upon secondary inactivity specifically for remote sessions, the remote ICA session may be dropped, a modal window may be launched or at user's discretion, the window may be closed.

A remote session may be launched as a separate window outside of the host Hyperspace on the host workstation or as a Window within Window.

Preferably, the Pool Manger is a Windows server running a “Pool Manager” service. While the present example discusses only one Pool Manager, multiple Pool Mangers may be used to make the invention scalable to accommodate increased volume of data transfer.

The main functions of the Pool Manager include initiating a configurable number of Hyperspace sessions per deployment and keeping them alive, tracking all Hyperspace sessions per deployment and having an interface for listening on a well known port (known to all hosts) for requests from a host for a remote connection. The configuration methodology may be fixed (i.e., maintain two pooled sessions per deployment) or may by dynamically determined based on factors such as server load, request traffic, number of users, or others as one skilled in the art will recognize.

Furthermore, the Pool Manager maintains a table to track activity. Following is an exemplary table to illustrate a table for maintaining and tracking all Hyperspace sessions per deployment.

| Deployment | Session Name | Session ID | Session ID |
|---|---|---|---|
| Dep B | “abc” | 1 | Active |
| Dep B | “xyz” | 2 | Disconnected |
| Dep B | “pqr” | 10 | Down |
| Dep C | “ijk” | 5 | Active |
| . . . | . . . | . . . | |

Generally, the Pool Manager status should be updated when the Pool Manager disconnects from an active session and hands off that session to a client. Optionally, the Pool Manager may also maintain a constant pool of Hyperspace sessions by starting a new one when a session is handed off to a client.

The Pool Manager has an interface for listening on a well known port (known to all hosts) for requests from a host for a remote connection. When the Pool Manager receives a request to launch HypB on Dep B for example, it queries its table for availability of an active HypB session. It chooses the first one that is available (session 1). It releases its connection to session 1 and marks the status of session 1 to “disconnected” and sends response back to the host.

A remote Hyperspace session may run a Login Manager Service. The Pool Manager may connect to a remote Hyperspace session, however, upon remote access request; the Pool Manager may pass the login values (that it obtained via the request from the Client) to the remote Hyperspace application and then disconnect itself. The Login Manager then reads the login values and logs in the user. After the Launch Manager on the client receives the session information, it reconnects to the session. When the user on the host closes the remote Hyperspace session, the Citrix connection is automatically dropped. The Pool Manager records the disconnected session for the next time it enumerates different sessions and updates its table.

Overall, the remote deployment system and a method of remotely accessing multiple databases provide rapid, seamless and efficient access to data from multiple databases. However, the present invention may have other applications. Thus, although the invention has been herein shown and described in what is perceived to be the most practical and preferred embodiments and examples, it is to be understood that the invention is not intended to be limited to the specific embodiments or examples set forth above. Rather, it is recognized that modifications may be made by one of skill in the art of the invention without departing from the spirit or intent of the invention and, therefore, the invention is to be taken as including all reasonable equivalents to the subject matter of the appended claims.

1. A remote deployment access system for use in accessing, storing or manipulating information from at least one remote deployment system, comprising:
a base deployment system having a first data repository for accessing, storing or manipulating data;
at least one remote deployment system having a second data repository for accessing, storing or manipulating data;
a user interface for the base deployment system for accessing, storing or manipulating the first or second data repository; and
a pool manager system having at least one pool session connecting the base deployment and the remote deployment systems.

2. The remote deployment access system of claim 1, wherein the base or remote deployment system comprises a plurality of software applications.

3. The remote deployment access system of claim 2, wherein a user moves between the pluralities of software applications.

4. The remote deployment access system of claim 2, wherein a user moves between the same software application located on at least two remote deployment systems.

5. The remote deployment access system of claim 3, wherein the user initiates a pool session from at least one software application on the base deployment system.

6. The remote deployment access system of claim 5, wherein the user further initiates a request for a remote session from the pool session to access the remote deployment system.

7. The remote deployment access system of claim 6, further comprising a launch manager system, wherein the launch manager system sends a request for the remote session to the pool manager system.

8. The remote deployment access system of claim 7, further comprising a locator system, wherein the locator system identifies a suitable remote session upon request from the user.

9. The remote deployment access system of claim 7, wherein the request for the remote session includes authentication information.

10. The remote deployment access system of claim 7, wherein the request for the remote session includes context information.

11. The remote deployment access system of claim 8, further comprising a database server system, wherein the locator system collects user-entered parameters from the user interface and queries the database server system.

12. The remote deployment access system of claim 11, wherein the database server system responds with a suitable remote deployment system and launches a new pool session.

13. The remote deployment access system of claim 12, wherein security clearance of the user in the base deployment system provides the authentication information.

14. The remote deployment access system of claim 13, wherein the pool manager system uniquely identifies the remote session.

15. The remote deployment access system of claim 14, wherein the user is directly connected via the base deployment system to the remote deployment via a virtual channel upon authentication.

16. The remote deployment access system of claim 15, wherein connection with the virtual channel causes disconnection of the remote session between the pool manager system and the remote deployment system.

17. The remote deployment access system of claim 16, wherein the virtual channel is disconnected upon access, manipulation or storage of data on the first or second repository.

18. The remote deployment access system of claim 17, wherein disconnection with the virtual channel causes connection of a second remote session between the pool manager system and the remote deployment system.

19. A remote deployment access system for use in accessing, storing or manipulating information from at least one remote deployment system, comprising:
a base deployment system comprising at least one health enterprise information system having a first data repository for accessing, storing or manipulating data;
at least one remote deployment system having a second data repository for accessing, storing or manipulating data;
a user interface for the base deployment system for accessing, storing or manipulating the first or second data repository; and
a pool manager system having at least one pool session connecting the base deployment and the remote deployment systems.

20. The remote deployment access system of claim 19, wherein the health enterprise information system comprises a plurality of software applications.

21. The remote deployment access system of claim 20, wherein a user moves between the pluralities of software applications.

22. The remote deployment access system of claim 21, wherein the user initiates a pool session from at least one software application on the health enterprise information system.

23. The remote deployment access system of claim 22, wherein the user further initiates a remote session from the pool session of the health enterprise information system to access the remote deployment system.

24. The remote deployment access system of claim 23, wherein a launch manager system sends a request for the remote session to the pool manager system.

25. The remote deployment access system of claim 24, wherein the request for the remote session includes authentication information.

26. The remote deployment access system of claim 25, wherein pool manager system uniquely identifies the remote session.

27. The remote deployment access system of claim 26, wherein the user is directly connected to the remote deployment via a virtual channel.

28. The remote deployment access system of claim 27, wherein the virtual channel is established between the first enterprise health system and a second health enterprise information system on the remote deployment base system.

29. The remote deployment access system of claim 27, wherein connection with the virtual channel between the first and the second health enterprise information systems causes disconnection of the remote session between the pool manager system and the remote deployment system.

30. The remote deployment access system of claim 29, wherein the virtual channel between the first and second health enterprise information system is disconnected upon access, manipulation or storage of data on the first or second repository.

31. The remote deployment access system of claim 30, wherein disconnection with the virtual channel between first and second remote health enterprise information systems causes connection of a second remote session between the pool manager system and the remote deployment system.

32. The remote deployment access system of claim 19, wherein the user interface includes a graphical interface representing at least one remote deployment system.

33. The remote deployment access system of claim 32, wherein the graphical interface displays an interactive map view of the remote deployment base.

34. The remote deployment access system of claim 33, wherein the graphical interface allows a user to perform actions on a patient in a health care facility.

35. The remote deployment access system of claim 34, wherein the graphical interface allows a user to direct workflow between the base deployment system and the remote deployment system.

36. The remote deployment access system of claim 35, wherein the workflow includes but is not limited to a call center, nurse triage, appointment scheduling, patient record viewing or manipulation, laboratory results, inpatient clinical record, ambulatory record, hospital billing, professional billing, provider information, physician information, prescription medication pharmacy information or insurance information.

37. The remote deployment access system of claim 36, wherein the locator system identifies suitable remote session for the user's workflow based on workflow context, including patient information, schedule information, location information or department information.

38. A method of accessing, storing or manipulating information from at least one remote deployment system, the method comprising the steps of:
initiating a pool session from a base deployment system;
maintaining at least one first remote session for each remote deployment system;
sending a request to a pool manager for a first remote session;
identifying a suitable remote deployment system;
authenticating request from a user and responding to the base deployment system with session information for the first remote session; and
connecting the base deployment system to the first remote deployment system via a direct virtual channel.

39. The method of claim 38, wherein the first remote session is disconnected once the virtual channel is established.

40. The method of claim 38, wherein a second remote session between the pool manager system and the remote deployment system is launched when the virtual channel is disconnected.

41. The method of claim 38, wherein the base deployment system or the remote deployment system comprises an enterprise health information system.

42. The method of claim 41, wherein the enterprise health information system further comprises a plurality of software applications.

43. The method of claim 42, wherein a user moves between the plurality of software applications.
